(19) United States
(12) Patent Application Publication
(10) Pub. No.: US 2015/0041486 A1
(43) Pub. Date: Feb. 12, 2015

(54) VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: LONG-WEI SHEN, Wuhan (CN); CONG-XU HU, Wuhan (CN); YONG-NIAN CHEN, Wuhan (CN); LI-FU XU, Wuhan (CN)

(21) Appl. No.: 14/452,674

(22) Filed: Aug. 6, 2014

(30) Foreign Application Priority Data
Aug. 8, 2013 (CN) 2013103432144

(51) Int. Cl. G07F 11/04

(52) U.S. Cl. CPC G07F 11/04
USPC 221/154

(57) ABSTRACT

A vending machine includes a rack, a number of storage containers, a controlling chip, and a number of locking modules. The number of storage containers is accommodated in the rack. Each of the locking modules is secured to one corresponding storage container and electrically connected to the controlling chip. In an initial state of the locking modules, the storage containers are secured to the rack. The controlling chip is configured to unlock one of the locking modules to allow the corresponding storage container to be pulled out of the rack.

### CROSS-REFERENCE TO RELATED APPLICATIONS

This application claims priority to China Patent Application No. 201310343214.4 filed on Aug. 8, 2013 in the China Intellectual Property Office, the contents of which are hereby incorporated by reference.

### FIELD

The present disclosure generally relates to a vending machine.

### BACKGROUND

A vending machine usually includes a rack and a plurality of storage containers. The plurality of storage containers are vertically installed on the rack for receiving a variety of goods. When refilling the storage containers, two or more of the storage containers may be pulled out of the rack at a time. However, the rack may topple over when too many storage containers are pulled out of the rack at a time.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cutaway, exploded, isometric view of an embodiment of a vending machine.

FIG. 2 is a cutaway, isometric view of a rack and a storage container of FIG. 1.

FIG. 3 is an enlarged view of a circled portion II of FIG. 1.

FIG. 4 is a partially assembled view of the vending machine of FIG. 1.

FIG. 5 is an enlarged view of a circled portion V of the vending machine of FIG. 4, wherein a latching member is in an initial position.

FIG. 6 is similar to FIG. 5, but the latching member is in a second position.

FIG. 7 is an assembled view of the vending machine of FIG. 1, wherein one of the plurality of storage containers is in a locked state.

FIG. 8 is similar to FIG. 7, wherein one of the plurality of storage containers is in an unlocked state.

FIG. 9 is a block diagram of one embodiment of a vending machine.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

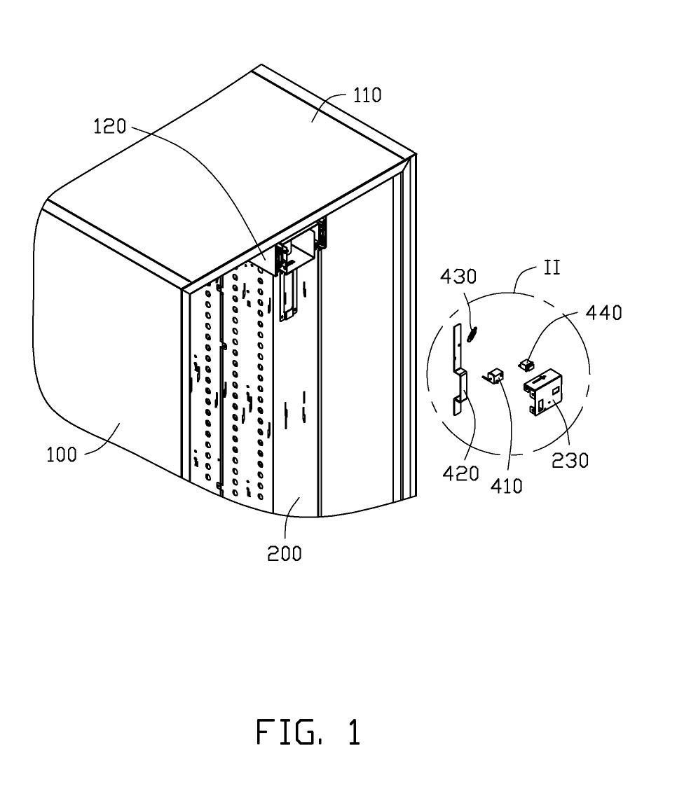

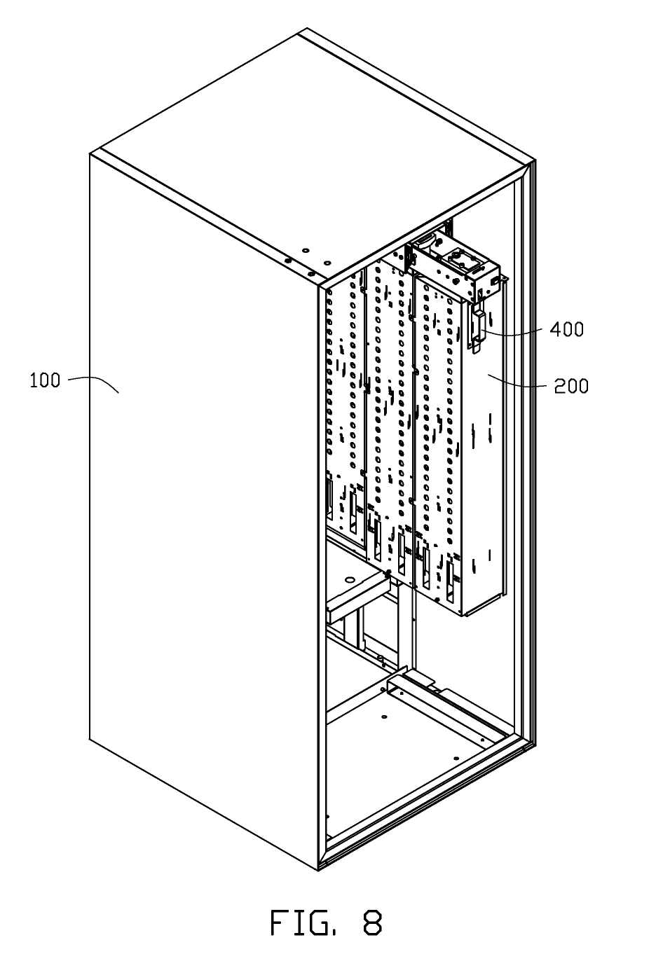

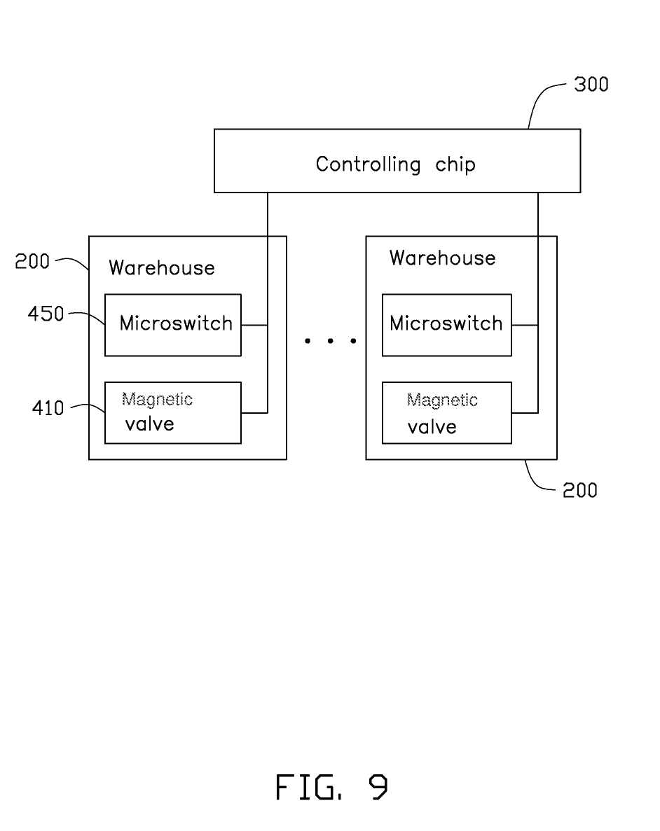

FIG. 1 shows an embodiment of a vending machine. The vending machine includes a rack 100, a plurality of storage containers 200, a controlling chip 300 (shown in FIG. 9), and a plurality of locking modules 400 (shown in FIG. 8). The plurality of storage containers 200 can accommodate a plurality of goods, such as snacks, beverages, alcohol, cigarettes, lottery tickets, cologne, consumer products, or jewelry.

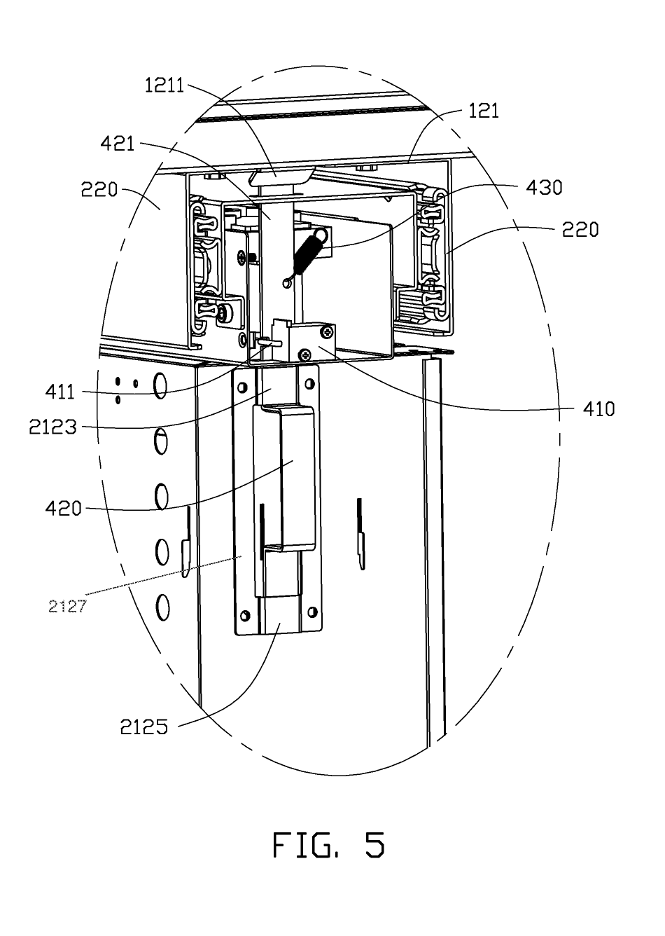

The rack 100 includes a top plate 110 and a plurality of sliding mechanisms 120 secured to the top plate 110. In one embodiment, the number of sliding mechanisms 120 is equal to the number of storage containers 200. Referring to FIG. 5, each of the plurality of sliding mechanisms 120 includes an installation plate 121 substantially parallel to the top plate 110. The installation plate 121 is secured to the top plate 110, and a stopping tab 1211 extends from a front end of the installation plate 121. In one embodiment, an acute angle is defined between the installation plate 121 and the stopping tab 1211. In another embodiment, the stopping tab 1211 is substantially perpendicular to the installation plate 121.

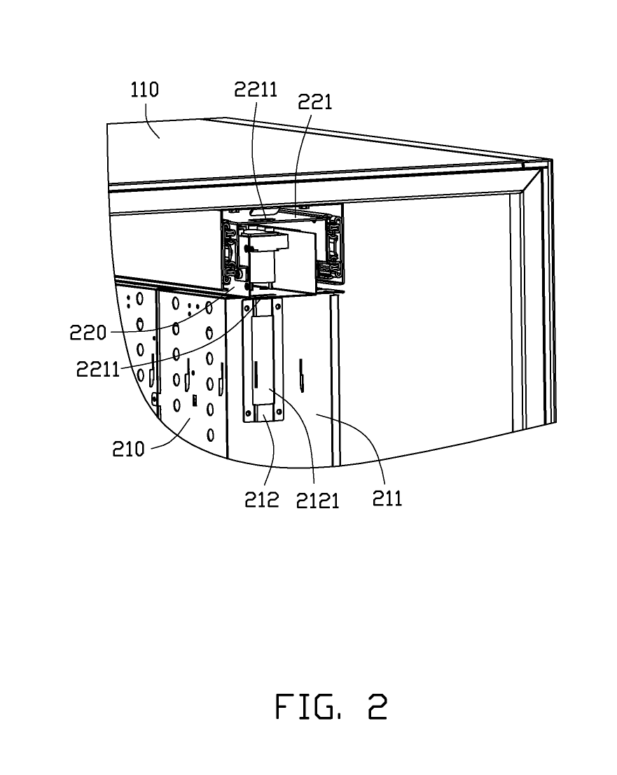

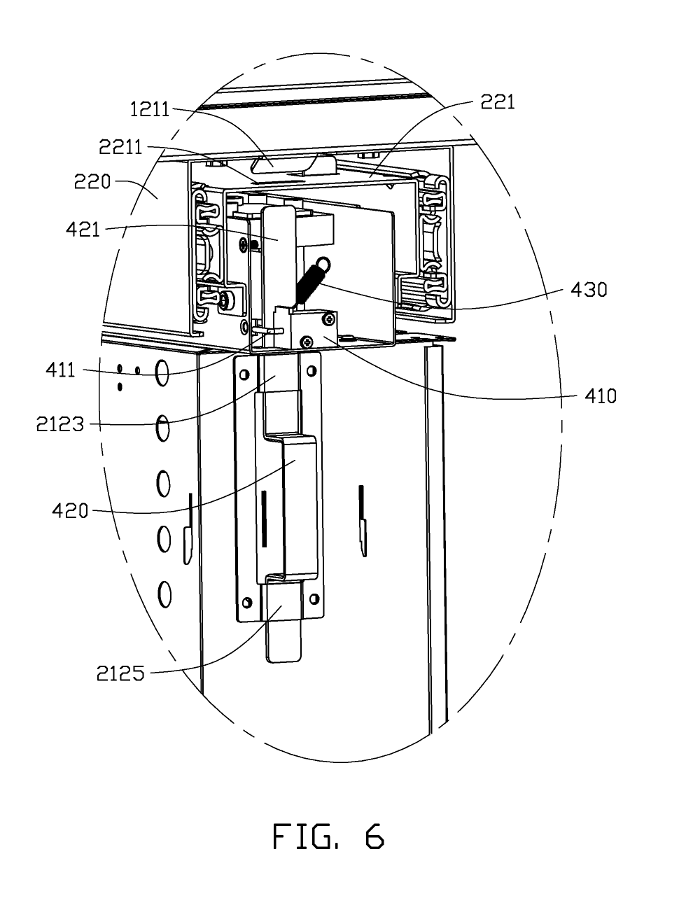

FIG. 2 shows that each of the plurality of storage containers 200 includes a main body 210, a hanging portion 220, a shielding cover 230 (shown in FIG. 1), and a pressing member 212. The hanging portion 220 is slidably received in the sliding mechanism 120 and includes two hanging plates 221 (shown in FIG. 6). The two hanging plates 221 are substantially parallel to each other and the installation plate 121. Each of the two hanging plates 221 defines a through hole 2211. The through holes 2211 are aligned with the stopping tab 1211.

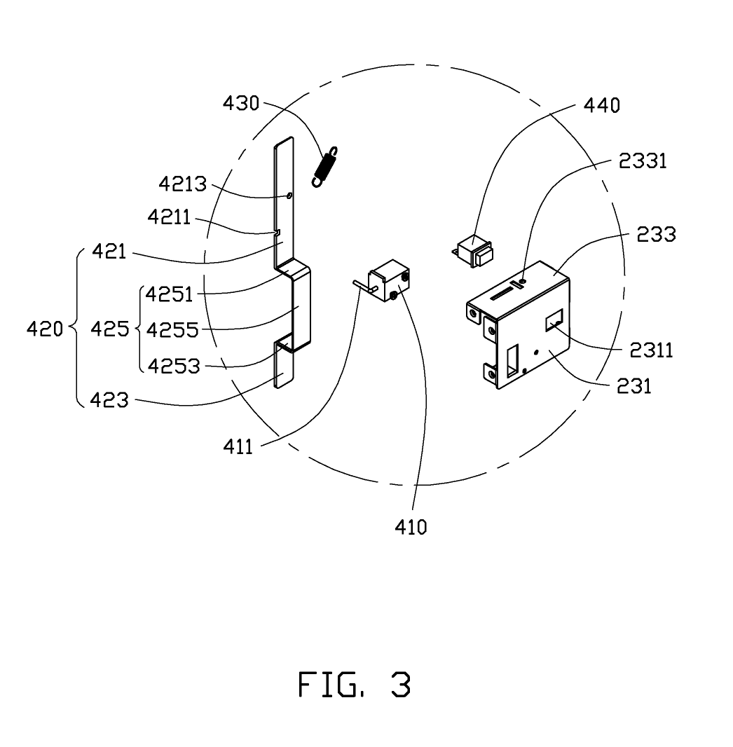

FIG. 3 shows that the shielding cover 230 includes a covering board 231 and a top piece 233 substantially perpendicularly connected to the covering board 231. The covering board 231 defines a fixing opening 2311 corresponding to the locking module 400. The top piece 233 defines a first mounting hole 2331 corresponding to the locking module 400. Referring to FIGS. 3, 5, and 6, the pressing member 212 can be secured to a front plate 211 of the main body 210 and includes a first bridge portion 2123, a second bridge portion 2125, and two connecting pieces 2127. The two connecting pieces 2127 are connected to the first bridge portion 2123 and the second bridge portion 2125. A latching opening 2121 is cooperatively bound by the first bridge portion 2123, the second bridge portion 2125, and the two connecting pieces 2127.

FIGS. 3 and 9 show that each of the plurality of locking modules 400 includes a magnetic valve 410, a latching member 420, a resilient member 430, a reset switch 440, and a microswitch 450. The magnetic valve 410 is electrically connected to the controlling chip 300, and a blocking pole 411 is formed in the magnetic valve 410. The blocking pole 411 can be extended from the magnetic valve 410 when the magnetic valve 410 is powered on, and retracted into the magnetic valve 410 when the magnetic valve 410 is powered off. In one embodiment, the resilient member 430 is an extension spring.

FIG. 3 shows that the latching member 420 includes a latching piece 421, a positioning piece 423, and an operation portion 425 connected to the latching piece 421 and the positioning piece 423. The latching piece 421 defines a cutout 4211 and a second mounting hole 4213. The operation portion 425 includes a first limiting piece 4251, a second limiting piece 4253, and an operation piece 4255 connected to the first limiting piece 4251 and the second limiting piece 4253. The first limiting piece 4251 is substantially perpendicularly connected to the latching piece 421 and the operation piece 4255. The second limiting piece 4253 is substantially perpendicularly connected to the operation piece 4255 and the positioning piece 423.

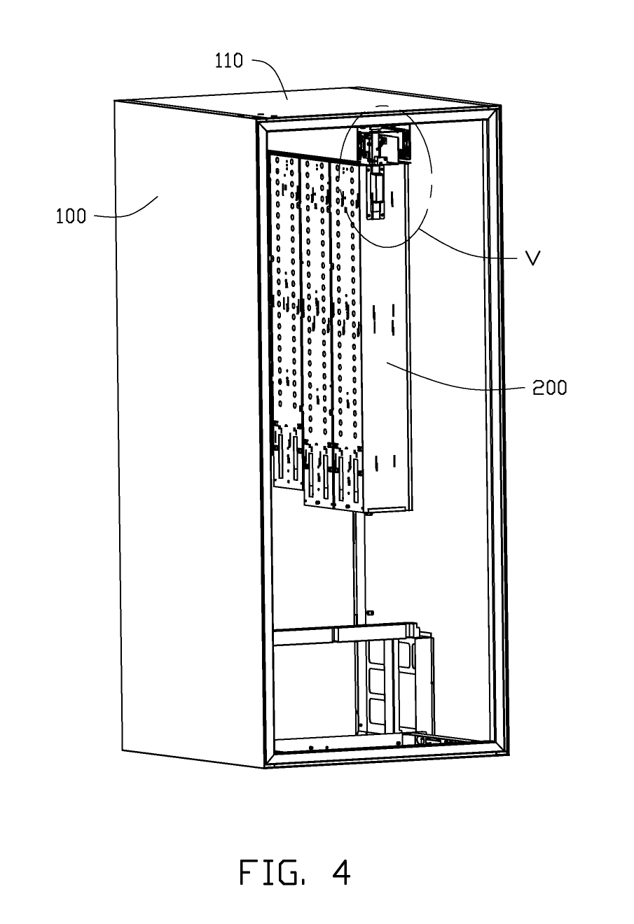

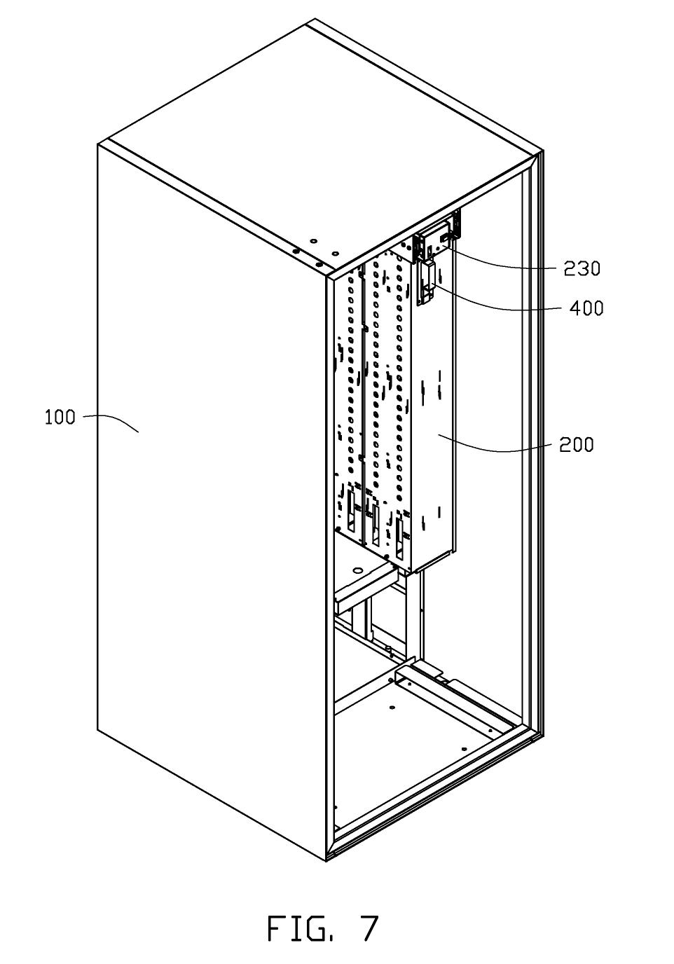

FIGS. 3-8 show assembled states of one of the plurality of storage containers 200 and one of the plurality of locking modules 400. The latching piece 421 extends through the through holes 2211 of the two hanging boards 221. The operation portion 425 extends through the latching opening 2121, and the pressing member 212 is secured to the front plate 211. The latching piece 421 is located between the first bridge portion 2123 and the front plate 211, and the positioning piece 423 is located between the second bridge portion 2125 and the front plate 211.

The shielding cover 230 is secured to a front end of the hanging portion 220. The magnetic valve 410 is secured to the covering board 231. The reset switch 440 is exposed through the fixing opening 2311. A first end portion of the resilient member 430 is engaged in the first mounting hole 2331, and a second end portion of the resilient member 430 is engaged in the second mounting hole 4213. In an initial position, the latching piece 421 is pulled by the resilient member 430 to resist the stopping tab 1211.

In use, the magnetic valve 410 of each of the plurality of locking modules 400 is electrically connected to the controlling chip 300, such that the magnetic valve 410 is powered on. The blocking pole 411 is extended out of the magnetic valve 410 and extends through the cutout 4211, to secure the storage containers 200 to the rack 100.

To refill one of the storage containers 200, the reset switch 440 of one of the plurality of storage containers 200 is pressed. The reset switch 440 sends a trigger signal to the controlling chip 300 to disconnect the controlling chip 300 from the magnetic valve 410 of the corresponding storage container 200, thereby powering off and unlocking the magnetic valve 410. Thus, the blocking pole 411 is retracted into the magnetic valve 410 to be removed from the cutout 4211. Thus, the storage container 200 is unlocked. The latching member 420 is pulled to move the latching piece 421 away from the stopping tab 1211, and the storage container 200 is pulled out of the rack 100. The microswitch 450 is released and switched off when the storage container 200 is pulled out of the rack 100. Meanwhile, the rest of the storage containers 200 remain locked.

After the storage container 30 is filled, the storage container 200 is pushed back into the rack 100 to be in the initial position. The microswitch 450 is squeezed by the rack 100 to be switched on to connect the controlling chip 300 to the magnetic valve 410, thereby powering on the magnetic valve 410, and the blocking pole 411 is extended out of the magnetic valve 410 to extend through the cutout 4211, thereby securing the storage container 200 to the rack 100. Thus, only one storage container 200 can be pulled out of the rack 100 at a time, and the rack 100 is prevented from toppling over.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a rack;
a plurality of storage containers accommodated in the rack;
a controlling chip; and
a plurality of locking modules, each of the plurality of locking modules being secured to each of the plurality of storage containers and electrically connected to the controlling chip;
wherein each of the plurality of locking modules is in a locked state and is engaged with the rack to secure each of the plurality of storage containers to the rack; the controlling chip is configured to unlock one of the plurality of locking modules to disengage the one of the plurality of locking modules from the rack so that the one of the plurality of storage containers is pulled out of the rack.

2. The vending machine of claim 1, wherein each of the plurality of locking modules comprises a reset switch and a magnetic valve; the reset switch and the magnetic value are electrically connected to the controlling chip, the controlling chip is configured to disconnect the magnetic valve to pull out of the one of the plurality of storage containers from the rack when the reset switch is pressed.

3. The vending machine of claim 2, wherein each of the plurality of locking modules further comprises a microswitch connected to the controlling chip; the controlling chip is configured to connect the magnetic valve to secure the one of the plurality of storage containers to the rack when the microswitch is switched on.

4. The vending machine of claim 2, wherein the rack comprises a plurality of sliding mechanisms, each of the plurality of storage containers comprises a hanging portion, and the hanging portion of each of the plurality of storage containers is slidably engaged with each of the sliding mechanisms.

5. The vending machine of claim 4, wherein each of plurality of sliding mechanisms comprises a stopping tab, each of the plurality of locking modules further comprises a latching member, and the latching member is movable relative to corresponding storage container between a first position and a second position; when the latching member is located in the first position, the latching member is engaged with the stopping tab; and when the latching member is located in the second position, the latching member is disengaged from the stopping tab.

6. The vending machine of claim 5, wherein a blocking pole is formed in the magnetic valve, the latching member defines a cutout; when the latching member is located in the first position, the blocking pole is engaged in the cutout; when the latching member is located in the second position, the latching member is disengaged from the cutout.

7. The vending machine of claim 5, wherein each of the plurality of storage containers comprises a shielding cover covering the hanging portion, each of the plurality of locking modules further comprises a resilient member, a first end of the resilient member is engaged with the shielding cover, a second end of the resilient member is engaged with the latching member, and the resilient member is resiliently deformable to move the latching member from the second position to the first position.

8. The vending machine of claim 5, wherein each of the plurality of storage containers comprises a main body and a pressing member secured to the main body, and the latching member is located between the main body and the pressing member.

9. The vending machine of claim 8, wherein each of the plurality of sliding mechanisms further comprises an installation plate, the stopping tab extends from the installation plate, and an acute angle is defined between the installation plate and the stopping tab or the stopping tab is substantially perpendicular to the installation plate.

10. The vending machine of claim 9, wherein the latching member is movable along a first direction that is perpendicular to the installation plate to disengage from the stopping tab, and along a second direction opposite to the first direction to engage with the stopping tab.

11. A vending machine, comprising:
a rack comprising a plurality of sliding mechanisms;
a plurality of storage containers, each of the plurality of storage containers being slidably suspended with each of the plurality of sliding mechanisms;
a controlling chip; and
a plurality of locking modules, each of the plurality of locking modules comprising a latching member and a magnetic valve, and the magnetic being electrically connected to the controlling chip;
wherein the magnetic valve is engaged with the latching member, and the latching member is engaged with the rack, to secure each of the plurality of storage containers to the rack; the controlling chip is configured to disconnect the magnetic valve of one of the plurality of locking modules, to disengage the latching member from the rack so that the one of the plurality of storage containers is pulled out of the rack.

12. The vending machine of claim 11, wherein each of the plurality of locking modules further comprises a reset switch; the reset switch and the magnetic value are electrically connected to the controlling chip, the controlling chip is configured to disconnect the magnetic valve, to pull out of the one of the plurality of storage containers from the rack when the reset switch is pressed.

13. The vending machine of claim 12, wherein each of the plurality of locking modules further comprises a microswitch connected to the controlling chip; the controlling chip is configured to connect the magnetic valve, to secure the one of the plurality of storage containers to the rack when the microswitch is switched on.

14. The vending machine of claim 12, wherein each of the plurality of storage containers comprises a hanging portion, and the hanging portion of each of the plurality of storage containers is slidably engaged with each of the sliding mechanisms.

15. The vending machine of claim 14, wherein each of plurality of sliding mechanisms comprises a stopping tab, the latching member is movable relative to corresponding storage container between a first position and a second position; when the latching member is located in the first position, the latching member is engaged with the stopping tab; and when the latching member is located in the second position, the latching member is disengaged from the stopping tab.

16. The vending machine of claim 15, wherein a blocking pole is formed in the magnetic valve, the latching member defines a cutout; when the latching member is located in the first position, the blocking pole is engaged in the cutout; when the latching member is located in the second position, the latching member is disengaged from the cutout.

17. The vending machine of claim 15, wherein each of the plurality of storage containers comprises a shielding cover covering the hanging portion, each of the plurality of locking modules further comprises a resilient member, a first end of the resilient member is engaged with the shielding cover, a second end of the resilient member is engaged with the latching member, and the resilient member is resiliently deformable to move the latching member from the second position to the first position.

18. The vending machine of claim 15, wherein each of the plurality of storage containers comprises a main body and a pressing member secured to the main body, and the latching member is located between the main body and the pressing member.

19. The vending machine of claim 15, wherein each of the plurality of sliding mechanisms further comprises an installation plate, the stopping tab extends from the installation plate, and an acute angle is defined between the installation plate and the stopping tab or the stopping tab is substantially perpendicular to the installation plate.

20. The vending machine of claim 19, wherein the latching member is movable along a first direction that is perpendicular to the installation plate to disengage from the stopping tab, and along a second direction opposite to the first direction to engage with the stopping tab.
